(19) United States
(12) Patent Application Publication
(10) Pub. No.: US 2006/0272507 A1
(43) Pub. Date: Dec. 7, 2006

(54) Adsorbent Carbon Breather with Scrim for Improved Flow

(76) Inventor: Christopher M. Johnson, Golden Valley, MN (US)

Correspondence Address: PAULY, DEVRIES SMITH & DEFFNER, L.L.C., P.O. BOX 2960, MINNEAPOLIS, MN, 55402-2960, US

(21) Appl. No.: 11/278,649

(22) Filed: Apr. 4, 2006

Related U.S. Application Data
(60) Provisional application No. 60/668,149, filed on Apr. 4, 2005.

(51) Int. Cl. B01D 53/02

(52) U.S. Cl. 96/134; 55/385.6

(57) ABSTRACT

A filter assembly for an electronic enclosure is disclosed. The filter assembly includes a screen or scrim material positioned at the bottom of adsorbent carbon media, the screen or scrim providing improved airflow along the bottom surface of the carbon media.

### PRIORITY

This application claims the benefit of U.S. Provisional Patent Application Ser. No. 60/668,149, filed Apr. 4, 2005, which application is hereby incorporated by reference in its entirety.

### BACKGROUND OF THE INVENTION

Hard disk drives are enclosures in which an inflexible platter coated with magnetic material is rapidly spun. A magnetic read/write head “flies” only a few microns above the disk on an air cushion. It is desirable to position the head as close to the disk as possible without touching it in order to provide a hard disk drive having high efficiency. It has been found that particulate and gaseous contaminants act to reduce efficiency and longevity of hard disk drives. Common sources of contaminants in disk drives include leaks, which may or may not be intentional; the manufacturing environment, which can contain certain contaminants; and the materials incorporated into the disk drives which give off particulates and gases. Thus, a need exists for filters, and filter media, for use in electronic enclosures to prevent entry of contaminants.

### SUMMARY OF THE INVENTION

The present invention is directed to a filter assembly for use inside an electronic enclosure, such as a hard disk drive enclosure containing a rotating disk. The filter assembly provides filtration of air entering the electronic enclosure, and optionally for air within the enclosure.

### DRAWING

The invention may be more completely understood in connection with the following drawing, in which:

FIG. 1 is a cross-sectional view of the filter assembly made in accordance with the invention, the filter assembly including an adsorbent material.

While the invention is susceptible to various modifications and alternative forms, specifics thereof have been shown by way of example and drawing, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION

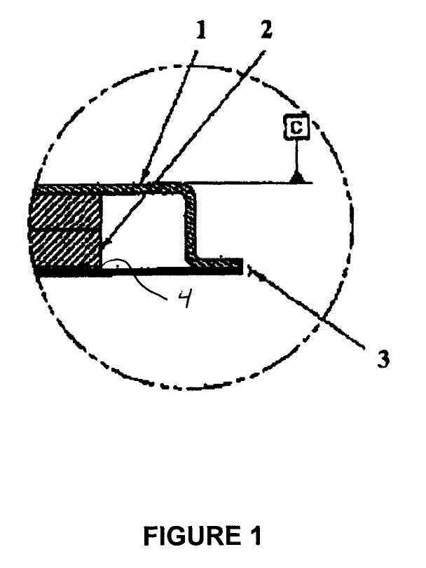

The present invention is directed, in part, to a filter assembly for an electronic enclosure. The filter assembly includes a screen or scrim material positioned at the bottom of adsorbent carbon media, the screen or scrim providing improved airflow along the bottom surface of the carbon media. Referring now to FIG. 1, a partial cross section of filter assembly made in accordance with an embodiment of the invention is shown, depicting a filter material 1 (such as expanded polytetrafluoroethylene); adsorbent media 2, placed on top of a scrim or screen material 4, plus bottom layer 3 containing an adhesive layer for securing the assembly to the interior of an electronic enclosure. Additional layers may also be included, but are not shown.

Suitable materials for the filter material 1 include microfiberglass media, high efficiency electret materials, and membrane materials such as, but not limited to, expanded polytetrafluoroethylene membrane, polypropylene membranes, polycarbonate and polyester membranes, mixed-esters of cellulose membranes, polyvinyl chloride membranes, cellulose triacetate membranes, and thin film composite membranes and/or laminates thereof. An especially suitable filtering 5 layer is expanded polytetrafluoroethylene (PTFE) because of its good filtration performance, conformability to cover adsorbent layers, and cleanliness. An example suitable expanded PTFE membrane has a filtration efficiency of 99.99% at 0.1 micrometer diameter sized particles with a resistance to airflow of approximately 20 mm water column at an airflow of 10.5 feet per minute.

The adsorbent media 2 may be selected from a broad range of adsorbents and is tailored to the particular gas or gases that are of concern. These gases include water vapor, dioctyl phthalate, silicone, chlorine, hydrogen sulfide, nitrogen dioxide, mineral acid gases, hydrocarbon compounds and any other gas that can 15 oxidize or cause corrosion of any critical element within the electronic enclosure or that can condense onto critical elements so as to effect their operation. The adsorbent media selected may be of a single type of a combination of different adsorbent medias. It may be a specifically selected adsorbent that targets a specific gas or may be a broad based adsorbent that has good adsorption properties over a 20 wide range of gases.

Acceptable adsorbent media include physisorbers such as, but not limited to silica gel, activated carbon, activated alumina, molecular sieves, or drying agents such as clays or super adsorbent fibers; or chemisorbents such as, but not limited to calcium carbonate, calcium sulfate, potassium permanganate, sodium carbonate, potassium carbonate, sodium phosphate, powdered or activated metals or other reactants for chemically reacting and scavenging gas phase corrodents or contaminants.

If a combination of adsorbents is used, they may be individual layers that are positioned on top of each other, or combined into one layer. Alternatively, the adsorbent media may be one that has been impregnated with one or more additional adsorbents such as, but not limited to, activated carbons, silica gels or aluminas that have been impregnated with one or more chemisorbents as mentioned above. An advantageous broad range adsorbent is activated carbon with a wide pore size distribution that has been impregnated with one or more chemisorbents such as calcium carbonate or sodium carbonate. Not all of the carbon's pores need be taken up with the impregnation. To fabricate a broad based physisorbent, a wide pore size distribution may be used to provide for a broad range of gasses to be adsorbed. The carbonates are typically good impregnation candidates because the compounds being released due to the chemical reaction of the chemisorbents are carbon dioxide, oxygen, and water. A preferred adsorbent for a given contaminant depends upon the contaminant, the pore size of the physisorbent and chemical composition of the chemisorber that is selected so as to optimize performance on that particular contaminant.

Suitable screen or scrim materials 4 include, for example polyethylene screens, For example, Delnet PQ214 apertured film from DelStar Technologies, made of high density polyethylene, is one suitable material. Said material may have, for example, Frazier Air Permeability at 0.5 inches of water of 390 feet per minute average, with no reading below 350 feet per minute, and a thickness of about 0.007 inches, and a basis weight of 1.3 ounces per square yard, with a melting point of about 275° F.

It will be appreciated that, although the implementation of the invention described above is directed to a hard drive enclosure, the present device may be used with other electronic enclosures, and is not limited to hard drive enclosures. In addition, while the present invention has been described with reference to several particular implementations, those skilled in the art will recognize that many changes may be made hereto without departing from the spirit and scope of the present invention.

We claim:

1. A filter assembly for an electronic enclosure, the filter assembly comprising:
adsorbent media; and
a scrim material positioned at the bottom of adsorbent the carbon media;
wherein the scrim provides improved airflow along the bottom surface of the carbon media.
